(19) United States
(12) Patent Application Publication
(10) Pub. No.: US 2007/0062387 A1
(43) Pub. Date: Mar. 22, 2007

(54) Inking and doctor unit for a rotogravure print and spread assembly

(76) Inventor: Domenico Percivalle, Rosignano Monferrato (IT)

Correspondence Address: DICKSTEIN SHAPIRO LLP, 1825 EYE STREET NW, Washington, DC, 20006-5403, US

(21) Appl. No.: 10/565,888

(22) PCT Filed: Jul. 23, 2004
(86) PCT No.: PCT/EP04/51597

§ 371 Date: Jul. 11, 2006

(30) Foreign Application Priority Data
Jul. 25, 2003 (IT) M12003A 001539

(51) Int. Cl. B41F 9/10

(52) U.S. Cl. 101/157; 101/169

(57) ABSTRACT

An inking and doctor unit for a rotogravure print and spread cylinder includes a casing; a doctor assembly; and an inking chamber bounded by a concave inner surface of the casing and at least partly by the doctor assembly. The casing and the doctor assembly form a box body closed except for one side engaging a print cylinder having a first axis; and the doctor assembly has a doctor mounted to lie flat with respect to a lateral surface of the print cylinder, when the box body engages the print cylinder.

### TECHNICAL FIELD

The present invention relates to an inking and doctor unit for a rotogravure print and spread assembly.

### BACKGROUND ART

As is known, rotogravure printing and spreading are performed by bringing a strip material (e.g. paper or polymer film) into direct contact with a print cylinder, the surface of which is etched with a pattern for printing. More specifically, the print cylinder rotates continuously at a predetermined constant speed. As it rotates, a portion of the cylinder surface is immersed in an ink tank, and a doctor blade removes the surplus ink from the surface. A pressure roller then presses the strip material against the surface of the print cylinder, substantially along a generating line, so that the ink is transferred from the print cylinder surface to one face of the strip material. For a given print cylinder circumference, output is obviously directly proportional to rotation speed.

Known rotogravure printing presses have various drawbacks. In particular, precisely on account of the high rotation speed of the print cylinder, part of the ink withdrawn during immersion inside the ink tank is spun off the cylinder surface and splashed onto surrounding components. Moreover, to leave enough room for the doctor and doctor carrier assembly, the ink tank cannot be located right next to the pressure roller, so that the inked portion of the print cylinder and the potential ink spin-off arc are fairly large. Ink splash obviously makes it necessary to clean all the components surrounding the print cylinder at the end of each printing cycle, especially when the type of ink being used is changed. And the cleaning work involved is a major handicap when making numerous short runs; in which case, overall downtime seriously affects efficiency in terms of utilization. Another drawback lies in the print cylinder remaining in contact with the surrounding air over the entire arc between the pressure roller and the ink tank, so that leftover ink not transferred to the strip material tends to dry and cake, thus preventing optimum inking of the cylinder surface, and seriously affecting printing quality.

### DISCLOSURE OF INVENTION

It is an object of the present invention to provide an inking and doctor unit for a rotogravure print and spread assembly, designed to eliminate the aforementioned drawbacks.

According to the present invention, there is provided an inking and doctor unit for a rotogravure print and spread assembly, as claimed in claim 1. By virtue of the characteristics claimed, the inking unit according to the invention is closed to prevent ink splash during printing and/or spreading, and so effectively protect surrounding components and drastically reduce downtime of the press, which is mainly due to the cleaning work required between successive printing cycles. By reducing downtime, the overall efficiency, in terms of utilization, of a print assembly incorporating the inking and doctor unit according to the invention is therefore greatly increased, especially in the case of short runs. Moreover, reducing the parts to be cleaned has the ecological advantage of reducing the amount of sludge (wash products) requiring disposal. And, since the inking and doctor housing is closed, smaller ink tanks can be used, thus also reducing the amount of leftover ink which must be stored but is rarely reusable.

Further advantages of the invention are claimed in the dependent Claims.

### BRIEF DESCRIPTION OF THE DRAWINGS

A non-limiting embodiment of the invention will be described by way of example with reference to the accompanying drawings, in which:

FIG. 1 shows a side view of a print assembly incorporating an inking unit in accordance with a first embodiment of the present invention;

FIG. 2 shows a top plan view, with parts removed for clarity, of the FIG. 1 assembly;

FIG. 3 shows a larger-scale lateral section of the FIG. 1 assembly along line III-III in FIG. 2;

FIG. 4 shows a schematic top view, with parts removed for clarity, of the FIG. 1 print assembly;

FIGS. 5 and 6 show larger-scale views of respective variations of a detail in FIG. 3;

FIG. 7 shows a larger-scale top view of a further detail in FIG. 3;

FIG. 8 shows a lateral section of the FIG. 7 detail along line VIII-VIII in FIG. 7;

FIG. 9 shows a top plan view of an inking unit in accordance with a second embodiment of the present invention;

FIG. 10 shows a schematic top view, with parts removed for clarity, of the FIG. 9 print assembly;

FIG. 11 shows a larger-scale top view of a detail in FIG. 9;

FIG. 12 shows a lateral section of the FIG. 9 detail along line XII-XII in FIG. 11;

FIGS. 13 and 14 show simplified, partly sectioned side views of inking units in accordance with a third and fourth embodiment respectively of the present invention;

FIG. 15 shows a schematic top view of a print assembly incorporating an inking unit in accordance with a fifth embodiment of the present invention.

### BEST MODE FOR CARRYING OUT THE INVENTION

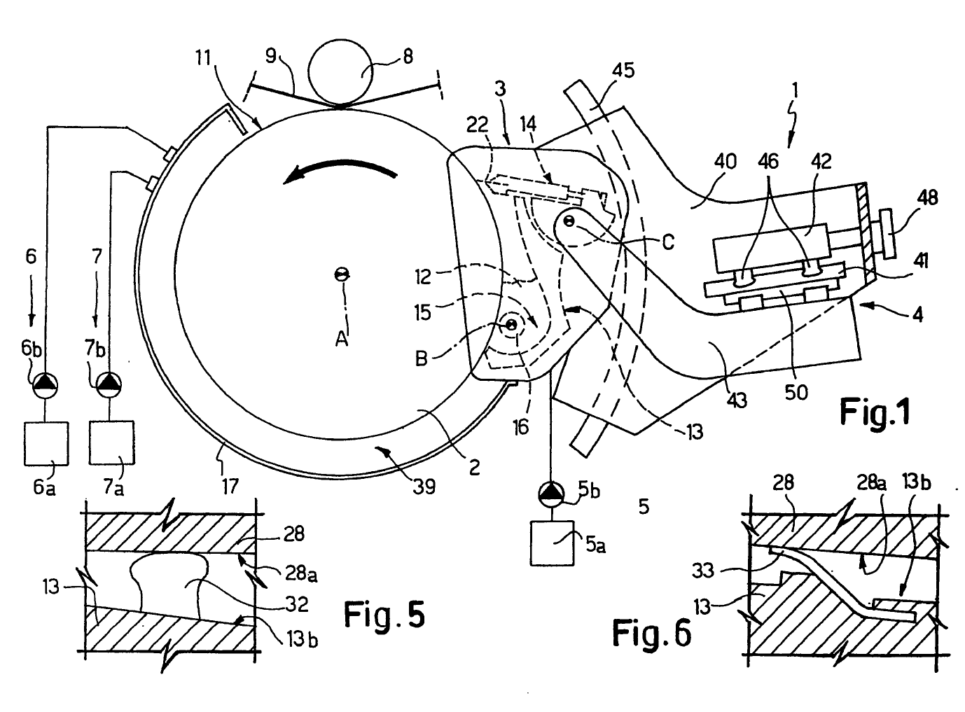

As shown in FIG. 1, a rotogravure print and spread assembly, indicated as a whole by 1, comprises a print cylinder 2; an inking and doctor unit 3; an actuating assembly 4 of unit 3; an inking circuit 5 of unit 3; a wetting circuit 6; a cleaning circuit 7; and a pressure roller 8. FIG. 1 also shows a portion of strip material 9, e.g. paper, fed to print assembly 1 by a feed unit (not shown).

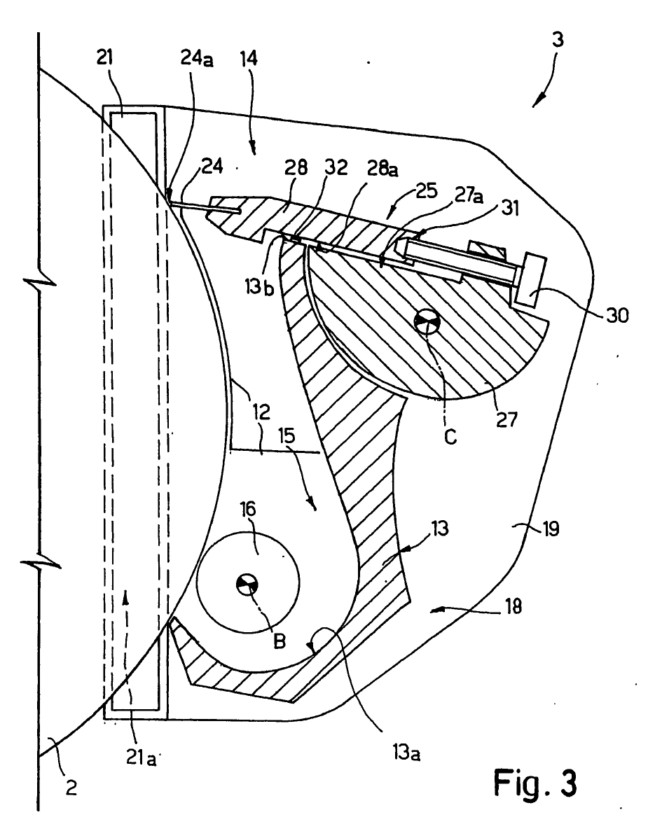

Print cylinder 2 is mounted on supports (not shown), rotates at a given angular speed (anticlockwise in FIGS. 1 and 3) about a horizontal axis A of rotation, has opposite end surfaces 10, and has a lateral surface 11 having a central printing portion 11a engraved with a pattern for printing. Pressure roller 8 engages lateral surface 11 of print cylinder 2 along a common generating line, and exerts a given pressure on strip material 9 which is fed continuously between pressure roller 8 and print cylinder 2.

Inking circuit 5 comprises a tank 5a containing ink 12; and an inking pump 5b for pumping ink 12 from tank 5a to unit 3. A known return conduit (not shown) is preferably also provided to recoup ink 12. Wetting circuit 6 comprises a tank 6a containing a wetting fluid, e.g. water; and a wetting pump 6b which draws from tank 6a and feeds the wetting fluid about lateral surface 11, preferably close to and downstream from pressure roller 8, as explained later on. Cleaning circuit 7 comprises a tank 7a containing a cleaning fluid, e.g. a solvent; and a cleaning pump 7b which draws from tank 7a and feeds the cleaning fluid in controlled manner onto lateral surface 11.

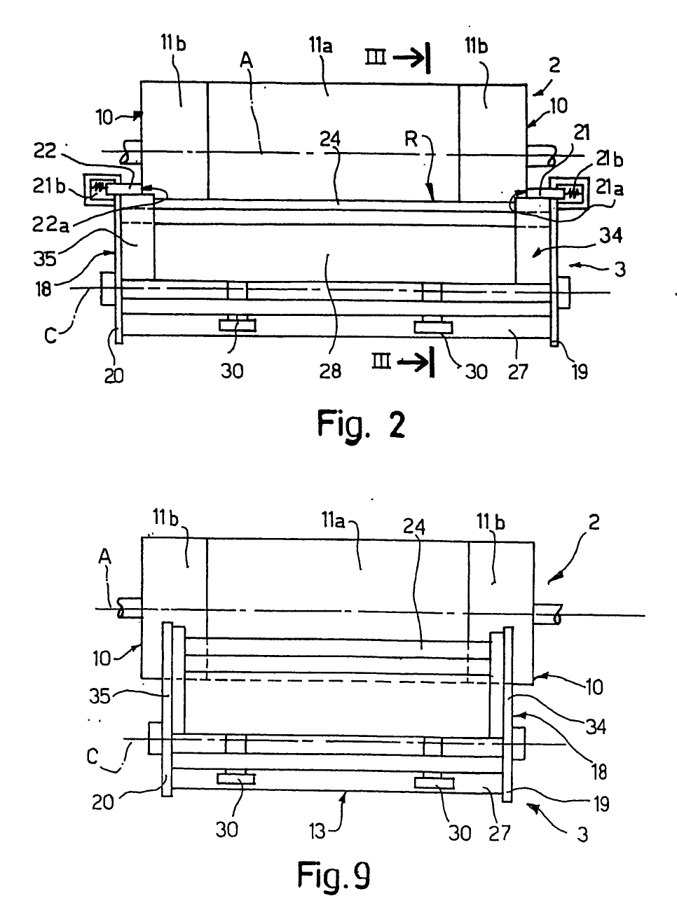

With reference also to FIGS. 2 and 3, unit 3 comprises a casing 13; a doctor assembly 14; an inking chamber 15; an inking roller 16 housed inside inking chamber 15 and having an axis B of rotation parallel to axis A of print cylinder 2; and a hood 17.

Casing 13 and doctor assembly 14 are fitted to each other to form a box body 18 closed except for one side which engages print cylinder 2. Inking chamber 15 is bounded by a concave inner surface 13a of casing 13, by doctor assembly 14 at the top, and by lateral surface 11 on the side engaging print cylinder 2. The ink 12 supplied by inking circuit 5 collects inside inking chamber 15, and wets lateral surface 11 as this rotates; and inking roller 16 presses ink 12 inside the cavities on lateral surface 11 to ensure optimum inking.

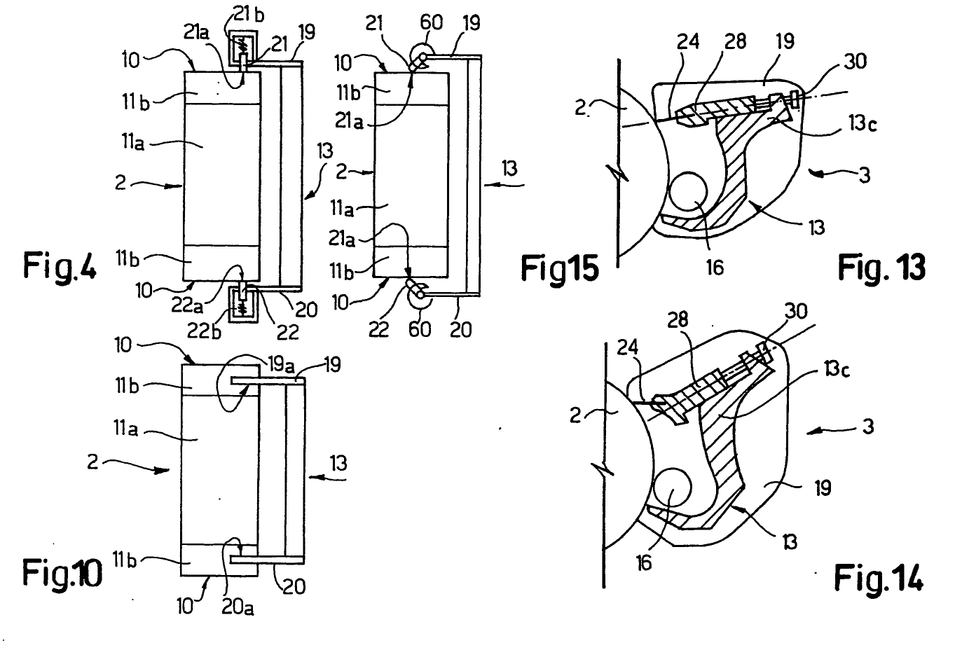

Casing 13 facing lateral surface 11 (FIG. 3) mainly extends in a direction parallel to axis A of rotation of print cylinder 2, and has respective lateral walls 19, 20 at opposite ends. Casing 13 is wider than print cylinder 2, and lateral walls 19, 20 extend so as to partly face respective end surfaces 10 of the print cylinder. As shown schematically in FIG. 4, lateral walls 19, 20 have respective plates 21, 22 hermetically engaging respective opposite end surfaces 10 of print cylinder 2 to prevent ink leakage. More specifically (FIGS. 2 and 3), respective facing edges 21a, 22a of plates 21, 22 define flat-surface sealing members, and are designed to slide on respective end surfaces 10. More specifically, edges 21a, 22a of plates 21, 22 rest on respective chords of end surfaces 10, slide on end surfaces 10 as print cylinder 2 rotates, and are made of antifriction material. For example, lateral walls 19, 20 and plates 21, 22 may be Teflon-coated or chromium-plated internally and on edges 21a, 22a; or edges 21a, 22a may be in the form of inserts made of PTFE, chromium-plated steel, felt, or other low-friction material. The contact area between plates 21, 22 and respective end surfaces 10 of print cylinder 2 may optionally be lubricated, e.g. with water or solvent. Plates 21, 22 are slidable parallel to axis A and perpendicular to respective lateral walls 19, 20 and to end surfaces 10, and are pressed against end surfaces 10 by elastic contrast members 21b, 22b (i.e. elastic contrast members 21b, 22b push plates 21, 22 towards each other), so that the distance between edges 21a, 22a of plates 21, 22 can be adjusted to use unit 3 with print cylinders 2 of different sizes. Moreover, unit 3 is movable back and forth, parallel to axis A of rotation, during operation of assembly 1, as explained later on, while still sealing the end surfaces of print cylinder 2.

Doctor assembly 14 (FIGS. 2 and 3) extends substantially the whole width of casing 13, is housed between and flush with lateral walls 19, 20, and comprises a doctor 24 fitted to a doctor carrier 25. Doctor 24 is a substantially rectangular blade preferably made of self-sharpening steel, and has a margin 24a resting on lateral surface 11, along a doctor line R coincident with a generating line of print cylinder 2. Doctor 24 is mounted to lie flat with respect to lateral surface 11 of print cylinder 2 in use, i.e. when unit 3 engages print cylinder 2. In other words, doctor 24 forms an acute angle with a plane tangent to lateral surface 11 along doctor line R, on the ink 12 feed side.

Doctor carrier 25 is housed between lateral walls 19, 20, and is movable angularly, with respect to casing 13, about a regulating axis C parallel to axis A of rotation of print cylinder 2. More specifically, doctor carrier 25 comprises a rocking support 27; and a slide 28 integral with doctor 24 and which slides on a flat surface 27a of support 27. Slide 28 and support 27 are connected to each other by actuating members 30 which, in the example shown, comprise at least two screws fitted in axially-fixed manner to support 27, and the free ends of which are inserted inside respective threaded seats 31 formed in slide 28. Together with flat surface 27a of support 27 and actuating members 30, slide 28 forms an adjusting mechanism by which to adjust the position of doctor 24 with respect to casing 13 (and therefore also with respect to lateral surface 11 of print cylinder 2), while support 27 acts as a doctor pressure adjusting mechanism. In other words, slide 28 and actuating members 30 provide for adjusting the position of doctor line R on lateral surface 11, and the parallelism of doctor 24 with respect to lateral surface 11. Moreover, wear of doctor 24 may be taken up. The pressure exerted by doctor 24 on print cylinder 2 can be adjusted by acting on support 27, e.g. by means of a hydraulic or pneumatic actuator (not shown).

Slide 28 has a sealing surface 28a adjacent to a sealing edge 13b of casing 13 and extending continuously along the whole width of and between the opposite ends of doctor assembly 14. Sealing edge 13b of casing 13 is fitted with a seal 32 (FIG. 5), e.g. made of felt or elastomeric material, to prevent leakage of ink 12 through the clearance between sealing edge 13b and sealing surface 28a. Alternatively (FIG. 6), sealing between casing 13 and slide 28 may be achieved using a flexible blade 33, e.g. made of PTFE, fixed to casing 13, close to sealing edge 13b, and loaded to rest against sealing surface 28a of slide 28.

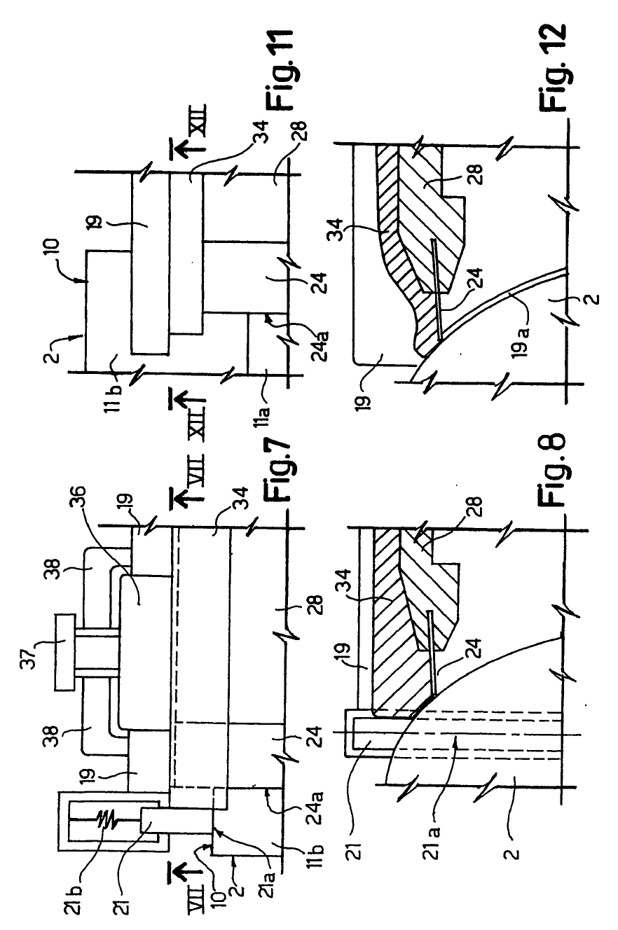

To also prevent leakage of ink 12 through the small clearance between doctor assembly 14 and lateral walls 19, 20, seals 34, 35 are fitted at opposite ends of doctor 24 and doctor carrier 25, flush with lateral walls 19, 20 (see also FIGS. 7 and 8). More specifically, seals 34, 35, which are made for example of elastomeric material, are pressed against lateral walls 19, 20, project slightly from doctor 24, and slide on lateral surface 11 of print cylinder 2; and respective portions of seals 34, 35 also contact respective plates 21, 22. As shown in FIG. 7, lateral walls 19, 20 have built-in PTFE pads 36 which are pressed against respective edges of doctor assembly 14 to prevent leakage of ink 12. More specifically, pads 36 are pressed by respective screws 37, with springs (not shown), inserted inside frames 38 fitted externally to lateral walls 19, 20. The pressure exerted on pads 36 is therefore adjustable.

With reference to FIG. 1, hood 17 is substantially cylindrical, and in use faces a portion of lateral surface 11 of print cylinder 2 extending (anticlockwise) between pressure roller 8 and inking chamber 15. In short, hood 17 defines a wetting chamber 39 for limiting airing of the substantially ink-free portion of lateral surface 11. Wetting circuit 6 and cleaning circuit 7 communicate with the inside of hood 17 through respective inlets to feed the wetting fluid and cleaning fluid respectively onto lateral surface 11 of print cylinder 2 in controlled manner. Lateral surface 11 is thus kept damp and prevented from drying during normal operation of print assembly 1, while the cleaning fluid fed into hood 17 provides for fast, automatic cleaning of print cylinder 2 and the inside of hood 17.

In the non-limiting embodiment described, actuating assembly 4 comprises a frame 40; a carriage 41 connected to frame 40 by a support 42; and arms 43 fitted to carriage 41 and connected to unit 3 so that doctor assembly 14 is movable angularly with respect to regulating axis C. Frame 40 is movable angularly about axis A and rotates unit 3. More specifically, frame 40 is movable along a circular rail 45 fitted integrally to a frame (not shown) of print assembly 1 and coaxial with print cylinder 2. Frame 40 and rail 45 are connected to each other by a known rotary actuating member (not shown, and comprising, for example, a motor-driven gear fitted to frame 40 and meshing with a rack fitted to rail 45). Support 42 is fitted slidably to frame 40 by means of an adjusting screw 48 by which support 42 is movable in a direction substantially perpendicular to axis A. Support 42 also has guides 46 parallel to axis A and perpendicular to the slide direction of support 42. Carriage 41 is movable along guides 46, and in turn has guides 50 substantially perpendicular to axis A and to guides 46. Arms 43 (only one of which is shown in FIG. 1) are integral with each other, and are fitted with pads which slide along guides 50; and unit 3 is mounted between the ends of arms 43, with doctor assembly 14 movable angularly about regulating axis C. In other words, actuating assembly 4 provides for rotating and translating unit 3 perpendicularly to axis A, so as to adjust the doctoring position and angle and so permit use of print cylinders 2 having different developments. The carriage 41 to frame 40 connection also allows unit 3 to move parallel to axis A: thus, alternating motion (back and forth), parallel to axis A, may be imparted to unit 3 to slide doctor 24 along doctor line R on lateral surface 11 and so clean doctor 24, even when assembly 1 is running. Obviously, even when doctor 24 is moved back and forth, sealing of end surfaces 10 of print cylinder 2 is assured by plates 21, 22, which slide with respect to lateral walls 19, 20 and are maintained contacting respective end surfaces 10 by elastic contrast members 21b, 22b.

In an alternative embodiment of the invention shown in FIGS. 9 to 12—in which, parts identical with or similar to those already described are indicated using the same reference numbers—casing 13 is narrower than print cylinder 2 but wider than print portion 11a of lateral surface 11. More specifically, the width of casing 13 is such that lateral walls 19, 20 rest directly on respective lateral portions 11b of lateral surface 11, axially outwards of print portion 11a. As shown schematically in FIG. 10, lateral walls 19, 20 hermetically engage lateral surface 11 to prevent ink leakage. More specifically (FIGS. 11 and 12), respective edges 19a, 20a of lateral walls 19, 20 define radial sealing members on lateral surface 11, and are shaped to slide on lateral surface 11 at least along an arc extending between an inlet edge of casing 13 (FIG. 1) and margin 24a of doctor 24 (i.e. doctor line R). Edges 19a, 20a of lateral walls 19, 20 are made of antifriction material. For example, lateral walls 19, 20 may be Teflon-coated or chromium-plated internally and on edges 19a, 20a; or, in this case too, edges 19a, 20a may be in the form of inserts made of PTFE, chromium-plated steel, felt, or other low-friction material. Lateral portions 11b of lateral surface 11 are preferably also chromium-plated or at any rate treated to reduce friction.

Further variations of the invention are shown in FIGS. 13 to 15. In the FIG. 13 variation, slide 28 supporting doctor 24 slides directly, without rocking, on a supporting portion 13c of casing 13, and unit 3 is connected to the actuating assembly 4 shown in FIG. 1. In the FIG. 14 variation, slide 28 slides on supporting portion 13c of casing 13 in a sloping direction with respect to the plane of doctor 24, and cooperates with actuating members 30 and supporting portion 13c to adjust both the doctoring position and pressure. In the FIGS. 13 and 14 variations, lateral walls 19, 20 of casing 13 rest on end surfaces 10 of print cylinder 2, whereas, in corresponding variations not shown, they rest on lateral surface 11.

In the FIG. 15 variation, plates 21, 22 are hinged to respective lateral walls 19, 20, and are pressed against end surfaces 10 of print cylinder 2 by torsion springs 50; and edges 21a, 22a of plates 21, 22 are rounded to ensure sealing regardless of the tilt of plates 21, 22 with respect to end surfaces 10 (e.g. during back and forth movement).

Clearly, changes may be made to the inking unit as described herein without, however, departing from the scope of the present invention. In particular, both the doctor position adjusting mechanism and the inking unit actuating assembly may be designed in various equivalent ways, but still in such a manner as to permit use of print cylinders of different developments, and control of the doctor position with respect to the print cylinder, and of doctoring angle and pressure. More specifically, mechanisms may be provided to translate and rotate the doctor and/or the entire inking unit in directions and about axes other than those described. The sealing system between the casing, doctor assembly, and print cylinder may also be other than as described; and all the embodiments described may be provided with hoods.

1) An inking and doctor unit for a rotogravure print and spread cylinder, comprising a casing (13); a doctor assembly (14); and an inking chamber (15) bounded by a concave inner surface (13a) of the casing (13) and at least partly by the doctor assembly (14); characterized in that the casing (13) and the doctor assembly (14) form a box body (18) closed except for one side engaging a print cylinder (2); and in that the doctor assembly (14) comprises a doctor (24) mounted to lie flat with respect to a lateral surface (11) of the print cylinder (2), when the box body (18) engages the print cylinder (2).

2) A unit as claimed in claim 1, characterized by comprising first sealing means (21, 21a, 22, 22a; 19a, 20a) for hermetic connection to the print cylinder (2).

3) A unit as claimed in claim 2, characterized in that the first sealing means (21, 21a, 22, 22a) are flat-surface sealing means designed to engage opposite end surfaces (10) of the print cylinder (2).

4) A unit as claimed in claim 3, characterized in that said first sealing means (21, 21a, 22, 22a) comprise a first and a second plate (21, 22) fitted at opposite ends of the casing (13) and having respective sealing edges (21a, 22a) facing each other and arranged to slide on respective said end surfaces (10) when the box body (18) engages the print cylinder (2).

5) A unit as claimed in claim 4, characterized in that the first and second plate (21, 22) are movable with respect to the casing (13); and by comprising elastic means (21b, 22b; 50) associated with the first and second plate (21, 22) to press the first and second plate (21, 22) against respective said end surfaces (10) when the box body (18) engages the print cylinder (2).

6) A unit as claimed in claim 2, characterized in that the first sealing means (19a, 20a) are radial sealing means shaped to engage the lateral surface (11) of the print cylinder (2).

7) A unit as claimed in claim 6, characterized in that the first sealing means (19a, 20a) are carried by the casing (13), at opposite ends of the doctor assembly (14), and comprise sealing edges (19a, 20a) of the casing (13) shaped to slide on the lateral surface (11) of the print cylinder (2) along at least a predetermined arc, when the box body (18) engages the print cylinder (2).

8) A unit as claimed in any one of the foregoing claims, characterized by comprising second sealing means (34, 35, 36) between the doctor assembly (14) and the casing (13).

9) A unit as claimed in claim 8, characterized in that the second sealing means (34, 35, 36) comprise seals (34, 35) located at opposite ends of the doctor assembly (14), flush with a first and second lateral wall (19, 20) respectively of the casing (13).

10) A unit as claimed in claim 9, characterized in that the second sealing means (34, 35, 36) comprise pads (36) made of low-friction material, incorporated in the first and second lateral wall (19, 20) of the casing (13), and located at opposite ends of the doctor assembly (14); and pressure means (37, 38) for pressing the pads (36) against the opposite ends of the doctor assembly (14).

11) A unit as claimed in any one of the foregoing claims, characterized by comprising third sealing means (32, 33) between a sealing surface (28a) of the doctor assembly (14) extending continuously along the whole width of the doctor assembly (14), and an edge (13b) of the casing (13) adjacent to the sealing surface (28a).

12) A unit as claimed in any one of the foregoing claims, characterized in that the doctor assembly (14) is movable with respect to the casing (13).

13) A unit as claimed in claim 11, characterized by comprising first adjusting means (27a, 28, 30; 28, 13c) for adjusting a relative position of the doctor (24) with respect to the casing (13).

14) A unit as claimed in claim 13, characterized in that the first adjusting means (27a, 28, 30; 28, 13c) comprise a slide (28) sliding on a support (27a; 13c) and integral with the doctor (24); and actuating members (30) for moving the slide (28) with respect to the support (27a; 13c).

15) A unit as claimed in any one of claims 12 to 14, characterized by comprising second adjusting means (27) for adjusting the pressure of the doctor (24) on the print cylinder (2).

16) A unit as claimed in claim 15, characterized in that the second adjusting means comprise a rocking member (27) connected to the doctor (24) and rotating about a regulating axis (C) parallel in use to an axis of rotation (A) of the print cylinder (2).

17) A unit as claimed in any one of the foregoing claims, characterized by comprising a hood (17) designed to define, in use, a wetting chamber (39) about a portion of the lateral surface (11) of the print cylinder (2) extending substantially between a print area (8) and the inking chamber (15).

18) A unit as claimed in claim 17, characterized by comprising first and second feed means (6, 7) for feeding a wetting fluid and a cleaning fluid respectively into the hood (17).

19) A rotogravure print and spread assembly comprising a print cylinder (2) having an axis of rotation (A); characterized by comprising an inking and doctor unit (3) as claimed in any one of claims 1 to 18.

20) An assembly as claimed in claim 19, characterized by comprising actuating means (4) for adjusting the relative position of the inking and doctor unit (3) with respect to the print cylinder (2).

21) An assembly as claimed in claim 20, characterized in that the actuating means (4) comprise rotary actuating means (40, 45) for rotating the inking and doctor unit (3) about the axis of rotation (A) of the print cylinder (2).

22) An assembly as claimed in claim 20 or 21, characterized in that the actuating means (4) comprise first translatory actuating means (41) for translating the inking and doctor unit (3) in a first direction substantially perpendicular to the axis of rotation (A); and second translatory actuating means (4) for translating the inking and doctor unit (3) in a second direction substantially parallel to the axis of rotation (A).
